(19) United States
(12) Patent Application Publication
(10) Pub. No.: US 2004/0260585 A1
(43) Pub. Date: Dec. 23, 2004

(54) Method and apparatus for measuring benefits of business improvements

(76) Inventors: Glynn Alan Spangenberg, San Diego, CA (US); William Patrick Doherty, San Diego, CA (US); Monica Lynn Wyly, San Diego, CA (US); James P. Scales, Winston Salem, NC (US); Dean Joseph Sipe, San Diego, CA (US)

Correspondence Address: Qualcomm Incorporated, Patents Department, 5775 Morehouse Drive, San Diego, CA, 92121-1714, US

(21) Appl. No.: 10/600,891

(22) Filed: Jun. 20, 2003

(51) Int. Cl. G06F 17/60

(52) U.S. Cl. 705/7

(57) ABSTRACT

A method and apparatus for measuring a benefit of business improvements. Actual performance information of a business is collected and stored in a storage device. The actual performance information is compared to estimated performance information prior to implementation of the business improvement. The benefit of the business improvement may then be measured by comparing the actual performance information to the estimated performance information.

### BACKGROUND

1. Field

The present invention relates to the field of data management and sales. More specifically, the ideas presented herein relate to a method and apparatus for measuring the benefits of improvements made to a business, such as the addition (or elimination) of hardware, software, and/or professional services.

2. Description of the Related Art

For years, business owners have strived to make their businesses as efficient as possible. Often, this involves making investments into new equipment, services, training, etc. Typically, it is difficult for such business owners to determine how much of an impact a particular investment or improvement to the business has had on the profitability of the business.

In the sales industry, return-on-investment estimates are typically provided to prospective customers as a way to entice them to purchase a product or a service. In some cases, a prospective customer provides a sales professional with a list of criteria pertinent to his or her business, and the sales professional enters the criteria into a computer program to estimate an amount of savings that could be expected if the prospective customer purchased the product or service and, therefore, a return-on-investment.

One problem of providing a return-on-investment estimate to prospective customers is that the prospective customer has no way to determine if the estimate is accurate or not. Therefore, many customers may not factor the return-on-investment estimate into the process of deciding whether or not to purchase the particular product or service. Sales professionals could potentially sell more products and services if their prospective clients could have confidence in the return-on-investment estimates. Therefore, what is needed is a way to determine an actual return-on-investment for products and/or services purchased.

### SUMMARY

The ideas presented herein comprise methods and apparatus for measuring a benefit of a business improvement. In one embodiment, a method for determining a benefit of a business improvement comprises operations of receiving actual performance information and storing the actual performance information in a storage device. At some later time, the actual performance information is retrieved and compared to estimated information to determine the benefit of the improvement, such as calculating an actual return-on-investment of the business improvement.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a satellite-based wireless communication system in which the method and apparatus for measuring benefits of business improvements may be used;

FIG. 2 is a functional block diagram of one embodiment of a mobile communication terminal used in the wireless communication system of FIG. 1;

FIG. 3 illustrates a functional block diagram of an apparatus for measuring benefits of business improvements; and

FIG. 4 is a flow diagram illustrating a method for measuring benefits of business improvements.

### DETAILED DESCRIPTION

The ideas presented herein describe measuring benefits of business improvements. In general, benefits are measured by comparing actual performance information from a business to estimated performance information over a predetermined length of time. However, it should be understood that the term “actual performance information” may comprise both actual performance information and estimated performance information.

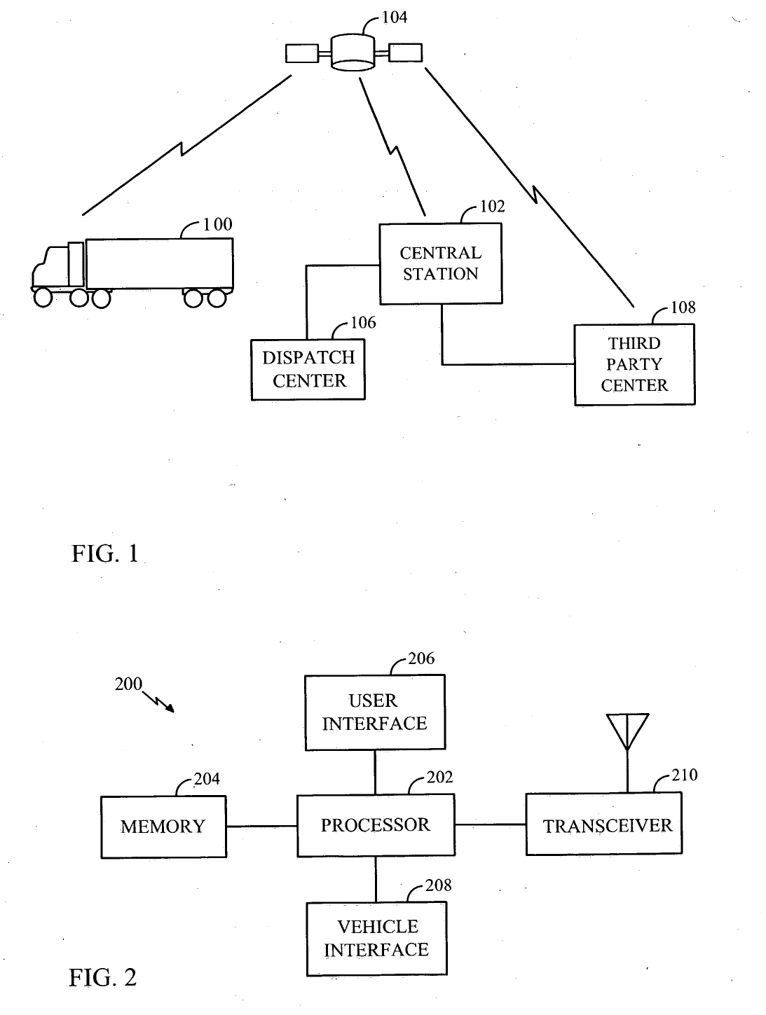

FIG. 1 illustrates a satellite-based wireless communication system widely used in the trucking industry for allowing two-way communications between vehicles and remotely-located entities, such as a fleet management center, family members, governmental authorities, and so on. Although the ideas presented herein for determining benefits to business improvements are described herein with respect to a satellite-based communication system, it should be understood that any other wireless communication system could be used in the alternative, including cellular and PCS terrestrial communications, microwave communications, 802.11 systems, PCMCIA cards, local infrared or radio frequency systems, and so on. It should also be understood that measuring the benefits of a business improvement as described herein may comprise measuring such things as increased revenues, decreased costs, reduction of overtime hours worked, reduction in the number of employees, an increase in average fuel efficiency, and so on. These benefits may further be used to calculate other benefits, such as an actual return-on-investment of an improvement, an actual net present value of an improvement, an actual total cost of ownership of an improvement, an actual internal rate of return, an actual payback time period, and/or other benefits. Generally, benefits are measured by comparing actual performance information of a business after a business improvement has been introduced, to estimated performance information prior to introduction of the business improvement.

A business improvement comprises anything that potentially adds value to a business, enables a business to be more efficient, introduces cost savings, increased revenues, improves customer satisfaction, improves employee retention and morale, and so on. Examples of business improvements comprise the addition of hardware, software, or professional consulting or other services to a business. It should also be understood that the ideas presented herein could also be used in conjunction with a number of different types of vehicles, such as buses, aircraft, automobiles, trains, or watercraft. Finally, the ideas presented herein could alternatively be used to measure a benefit for business improvements in any business, not just in a transportation or wireless communication setting.

Referring now to FIG. 1, vehicle 100, in this example, comprises a tractor-trailer, commonly used in the long-haul trucking industry. Vehicle 100 typically comprises a mobile communication terminal (MCT, not shown) for communicating with a central station 102 via satellite 104. Generally, the MCT resides onboard a tractor portion of vehicle 100. In one embodiment, central station 102 comprises a central processing center, otherwise known as a “hub” or “network management center (NMC) and serves as a central communication point between MCT-equipped vehicles and their respective dispatch centers, other designated office(s), shippers, consignees, governmental authorities, family members, and so on. For example, in FIG. 1, central station 102 routes communications in the form of text messages between dispatch center 106 and vehicle 100. Dispatch center 106 comprises a vehicle dispatch center which generally monitors and controls a fleet of vehicles, such as vehicle 100. Central station 102 may additionally provide other services to dispatch center 106, such as providing billing for use of the satellite system, message forwarding to third parties, message storage, etc.

Communications between dispatch center 106 and vehicle 100 may further be passed to one or more other remote locations, such as third party center 108. Third party center 108 comprises any number of interested third parties to communications between dispatch center 106 and vehicle 100. For example, third party center 108 could be a another designated office of dispatch center 106, a shipper of goods being carried by vehicle 100, a consignee of goods being carried by vehicle 100, a governmental unit, a personal computer, and so on. Communications among locations 102, 106, and 108 may be carried out by any known communication techniques, including telephone, internet, dedicated lines, wireless links, and so on. Information between these locations may also be exchanged by using physical media, such as disk drives, tapes, CD's, DVD's, and so on.

The MCT located on vehicle 100 transmits and receives communications wirelessly using, in one embodiment, a satellite 104. In other embodiments, the MCT uses a terrestrial wireless communication system to communicate with remote location 102, such as an analog or a digital cellular telephone system, an RF communication system, or a wireless data communication network, such as a cellular digital packet data (CDPD) network.

FIG. 2 is a functional block diagram of one embodiment of the MCT, shown as MCT 200. MCT 200 is typically purchased or leased by an entity such as a transportation company in the business of delivering goods from a pickup location to a destination location. In addition to purchasing or leasing MCT 200, the transportation company will additionally purchase or lease related equipment and/or services in order to use MCT 200. For example, additional hardware and software is typically needed at dispatch center 106. These components are generally supplied together as part of a complete communications package purchased or leased by the transportation company.

MCT 200 allows the driver to record various transactions for each stop that the vehicle makes. These transactions document delivery and pickup, overage and shortage, damaged or returned goods, etc. With customizable multi-tier transactions, a driver can enter the amount, price, and location of all fuel purchased along with other information necessary for International Fuel Tax Agreement (IFTA) compliance. In one embodiment, the MCT's basic configuration allows drivers to log state line crossings in a structured, graphic manner—he or she simply selects the appropriate state from a set of icons that represent adjacent states. MCT 200 keeps track of the trip duration and mileage accumulated in each state. With a GPS receiver and associated software installed, the state-line-crossing function may be automated. Drivers generally use transactions to report non-DOT information like expenses, meals, repairs, and other information. Transactions utilize prompts or simple messages to get specific information from drivers. Examples of transactions include Log Off, Log On, Odometer, Power Off, Power On, Shipper Information, and Trailer information.

MCT 200 may support grouping transactions in such a way that a transaction is part of a group that is part of another group. This tier system can have three levels, with the third level functioning as the actual transaction. For example, a Meals category could be created, then a Breakfast category could be created as a subset of the Meals category, and then a transaction named Continental could be created as a breakfast transaction. A transaction can include a number of prompts to collect data. Drivers enter data at these prompts, and MCT 200 records these data items. When a driver logs a transaction, MCT 200 sends it to central station 102 and/or dispatch center 106 with the time and date, and any data the driver included. Drivers may also record various activities using MCT 200. In one embodiment, drivers interact with a simple icon-assisted touch screen display whenever MCT 200 requires input. MCT 200 automatically records the time, location, and duration of each activity that occurs. Most activities are preddefined to meet general business requirements, for example, collecting driver payroll metrics. Activities are mapped to DOT status categories to automate the process of collecting DOT log information. Activities typically represent what a driver does at various times during his or her route. Activities may correspond to DOT status categories, such as Driving, Sleeper, On Duty, and Off Duty. MCT 200 tracks DOT status changes with the information recorded with activities chosen by the driver.

Most activities are on-duty activities because they occur while a driver is on duty. Activities of this type might be loading, unloading, paperwork, fueling, inspection, or any other meaningful activity that a business may expect its drivers to carry out. The Driving activity corresponds to the DOT status of Driving and is generally the only activity in that status. One may also associate other activities with the On Duty, Off Duty, or Sleeper statuses MCT 200 may support hundreds of activities including Driving, Off-Duty Driving, Off Duty, On Duty, Pre-Trip, and Post Trip activities.

MCT 200 generally comprises a processor 202, a memory 204, a user interface 206, a vehicle interface 208, and a transceiver 210. It should be understood that the functional blocks shown in FIG. 2 may be housed together in a single physical unit, or they may be distributed in any combination throughout vehicle 100. For example, the transceiver 210 may or may not be incorporated into the physical structure of MCT 200.

Processor 202 generally comprises circuitry necessary for executing machine-readable instructions stored in memory 204. For example, processor 202 may comprise a microprocessor and supporting circuitry, such as the Intel 80x86 or Pentium series of microprocessors. Of course, other electronic processors could be used in the alternative. Memory 204 may comprise one or more signal-bearing mediums tangibly embodying one or more programs of machine-readable instructions executable by a digital processing apparatus, such as processor 202. Typically, memory 204 comprises one or more volatile and/or non-volatile memories, such as a read-only memory (ROM), random-access memory (RAM), electrically erasable programmable read-only memory (EEPROM), a hard drive, a floppy disk drive and floppy disk, or a flash memory. Memory 204 is used to store instructions for the operation of MCT 200. Typically, this includes receiving various performance characteristics of vehicle 100, such as vehicle location, vehicle speed, engine RPM, load status (i.e., vehicle loaded/unloaded, a description of the goods, a description of the pickup and/or delivery location of the goods, etc), driver status (i.e., an identification of who is operating the vehicle, who is a vehicle occupant, a duty status of the driver/occupant, etc.). Further, instructions may be stored for allowing a vehicle operator/occupant to send and receive audible or text communications.

User interface 206 allows a vehicle operator/occupant to enter instructions or information into processor 202, typically comprising a keyboard or keypad and a visual display device. Of course, user interface 206 could alternatively comprise other types of interfaces, such as a microphone for entering audible commands, a pointing device such as a mouse, light pen, trackball, and/or a speaker for generating audible information to a vehicle operator. Other types of well-known devices could be used, either alternatively or in combination, with the devices just mentioned. For example, vehicle operator interface may, alternatively or in addition, comprise a bio-metric device or a card reader.

Vehicle interface 208 allows processor 202 to communicate with one or more electronic control units (ECUs) located onboard vehicle 100, either directly, or through one or more intermediary devices, such as an onboard computer (not shown). Vehicle interface 208 comprises a communication port such as a serial data port for communicating, for example, with an onboard computer. Alternatively, vehicle interface 208 comprises a port for interfacing to a vehicle data bus, such as a J1708 data bus commonly used in vehicles today. Examples of ECUs include a fuel regulator/cutoff switch, an ignition controller, an electronic transmission controller, a steering wheel locking mechanism, and a brake activation unit. Other examples of ECUs include electronic devices which provide operational information about vehicle 100 to processor 202. For example, these types of ECUs comprise a speed sensor, an RPM sensor, an odometer, or a location sensor such as a GPS receiver.

In modern vehicles, the ECUs may be interconnected by a data bus, such as a data bus as specified in SAE J1708, a commonly known communication standard. The data bus is connected to vehicle interface 208 so that communications may take place between processor 202 and the various ECUs connected to the data bus.

Transceiver 210 comprises a transmitter to modulate information from processor 202 and convert the modulated information into high frequency signals suitable for wireless transmission. Similarly, transceiver 210 also comprises a receiver to convert received high frequency communication signals into signals suitable for demodulation and subsequent processing by processor 202.

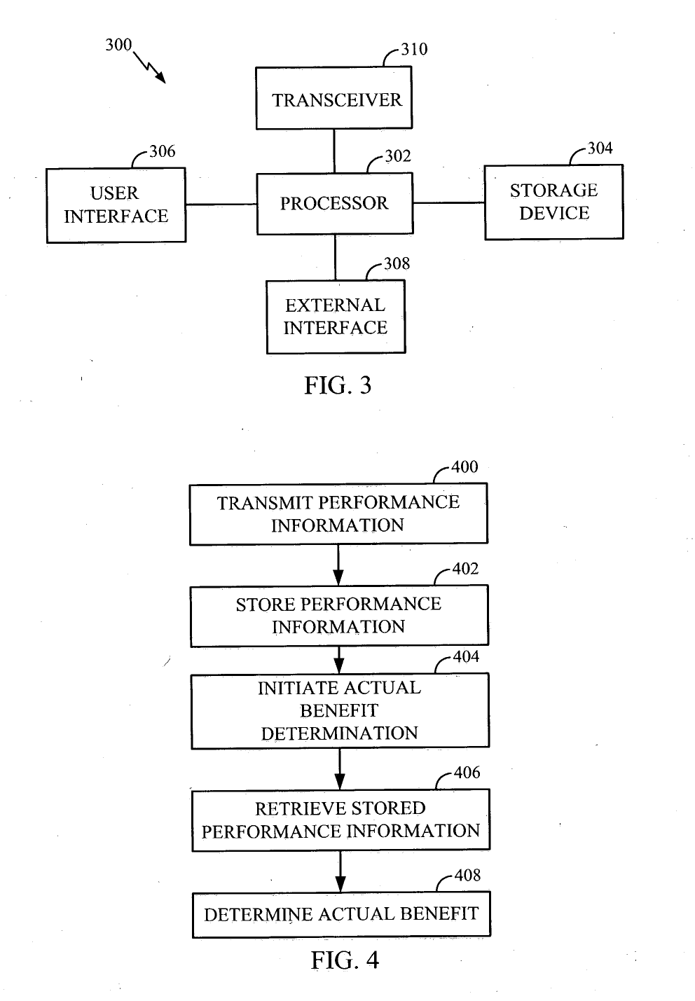

FIG. 3 illustrates a functional block diagram of an apparatus 300, typically a processing device such as a desktop or mainframe computer, for measuring benefits of business improvements, located at central station 102. Apparatus 300 typically comprises a processor 302, a storage device 304, and at least one interface. It should be understood that processor 302 and storage device 304 could be located remotely from each other. The interface may comprise a user interface 306, a transceiver 310, and/or an external interface 308. It should be noted that the apparatus described in FIG. 3 could alternatively be located at central station 102, dispatch center 106, third party center 108, or at some other location. Furthermore, each component of apparatus 300 may be located at different physical locations, the components typically in communication with each other via one or more data networks, telephonic systems, etc.

Processor 302 generally comprises circuitry necessary for executing executable computer instructions stored in storage device 304. For example, processor 302 may comprise a microprocessor and supporting circuitry, such as the Intel 80x86 or Pentium series of microprocessors. Of course, other electronic processors could be used in the alternative. Processor 302 measures a benefit of a business improvement using actual performance information of the business, storing the actual performance information in storage device 304. For example, processor 302 may be used to determine an actual return-on-investment on hardware, software, and/or services used to communicate with one or more vehicles. In the present example, this may include MCT 200, apparatus 300, software needed to operate MCT 200 and apparatus 300, as well as any services necessary to install, configure, and teach operation of the hardware and software.

The benefit of a business improvement may be measured in a number of different ways. Examples include measuring such things as increased revenues, decreased costs, reduction of overtime hours worked, reduction in the number of employees, an increase in average fuel efficiency, reduction of idle time, and so on. These benefits may further be used to calculate other benefits, including an actual return-on-investment of an improvement, an actual net present value of an improvement, an actual total cost~of ownership of an improvement, an actual internal rate of return, an actual payback time period, and/or other benefits. Generally, benefits are measured by comparing actual performance information of a business after a business improvement has been introduced, to estimated performance information prior to introduction of the business improvement.

In the present example, a business improvement comprises the addition of a mobile communication system to one ore move vehicles 100, comprising MCT 200, apparatus 300, related software, and/or related support. Prior to this business improvement, drivers may have spent one hour each day reporting their daily activities (such as the time and date of each stop made and the reason for doing so, processing bills of lading, etc.) into a paper log book. The logbook may have then been provided to fleet management where the driver's time is entered into a computer system for payroll purposes or other purposes, such as for governmental, regulatory, or legal purposes. The various activities of the driver may additionally be entered into a computer for logistical purposes. If the time spent carrying out these activities are automated and, therefore, reduced or eliminated, the time saving may be converted into a cost savings to fleet management. A profitability analysis over a predetermined time period using actual performance information would result in (hopefully) increased profitability compared to the profitability analysis prior to addition of the wireless communication system using estimated performance information. The cost of the wireless communication system could then be subtracted from the difference in profitability to arrive at an actual return-on-investment.

Calculating an actual return-on-investment generally comprises determining a cost benefit of having the improvement. It may be defined as a net profit increase over a predetermined time period after implementing the improvement and then subtracting the cost of the adding the improvement. In one embodiment, a profit analysis is performed after implementing the improvement, using actual performance information of the business over a predetermined time period. This is compared to a profit analysis over a same time period length using estimated performance information, prior to implementation of the improvement. The difference in these two figures represents a net profit (or loss) over a predetermined time period after implementing the business improvement. An actual return-on-investment can be calculated by subtracting the cost of the improvement from the net profit (or loss). In another embodiment, the net profit (or loss) is multiplied by a number equal to an expected life of the improvement divided by the predetermined time period. For example, if a profit analysis was performed using actual performance information over a predetermined time period of 6 months, and the improvement is expected to have a life of 5 years, then the net profit (or loss) over a six month period would be multiplied by 10 (5 years divided by 6 months, or half a year) to obtain a profit (or loss) over the expected life of the improvement.

In the simplest case, a business improvement may simply comprise the passing of time. For example, after installing a wireless communication system on a fleet of vehicles, actual performance information obtained from the business over an initial six month period using the wireless communication system may be used to calculate a benefit of the wireless communication system during that time period. For example, an actual return-on-investment of the wireless communication system may be calculated. As time goes by, efficiencies provided by the wireless communication system may increase, due to user familiarity, for example. Subsequent benefit calculations may be performed by comparing a benefit using actual performance information of, for example, the initial six month time period, to a benefit using actual performance information over another time period subsequent to the initial time period. The subsequent time period does not have to equal the initial time period (the benefits can be normalized).

Such comparisons of actual performance information may be especially useful when an improvement to a system is implemented. For example, if consultant services are used to improve any aspect of a business operation, a performance improvement may be measured by comparing actual performance information prior to use of the services and actual performance information after the services have been rendered. In another example, actual performance information may be compared against actual performance information when a change of business conditions occur, such as a competitor going out of business, a change in fuel prices occurs, an addition or elimination of labor, etc.

Just about any type of improvement to a business can be the basis for measurement the benefit of the improvement. Examples include the addition or removal of software, hardware, services, employees, business practices, employee training, and so on. In any case, actual performance information using the improvement is compared to either actual or estimated information prior to use of the improvement, and the difference between the two are used to calculate a benefit. The actual performance information comprises any information produced by a business. Examples include a cost to produce a device, hours spent by employees on one or more operations in a service, time to produce a good or complete a service, actual miles traveled by a vehicle, an average number of vehicle stops over a given time period, and so on. The estimated performance information typically comprises an estimate of the just-mentioned information prior to use of the improvement. The reason that an estimate is used is typically because the actual information was not able to be measured prior to use of the improvement. However, there are cases in which actual performance information can be measured both before and after implementation of an improvement. In these cases, a benefit can be measured by comparing actual performance information before and after implementation of the improvement.

Another benefit that may be calculated is referred to herein as an actual total cost of ownership benefit. This may be defined as the actual return-on-investment benefit described above, subtracting costs indirectly associated with the business improvement(s). Such indirect costs may comprise costs associated with training employees on how to use the improvement, temporary productivity losses resulting from bringing employees “up to speed” with the new improvement, costs of integrating the improvement with other logistics systems, etc. Processor 302 may use actual performance information, estimated performance information, or a combination of both, to determine the indirect costs. For example, actual costs of training employees, taken from a business's billing system, may be used as actual performance information, while an estimate of temporary productivity loss from implementing the new improvement might be used as estimated performance information.

Yet another benefit that may be calculated is an actual net present value benefit. This is generally defined as the present value of cash inflows minus the present value of cash outflows. Net present value discounts future inflows and outflows at an appropriate market interest rate to determine an amount of money in present standards. Net present value helps an investor determine how much money he or she would need today to substitute for making an investment. If the number is positive, the investor should make the investment, generally speaking.

Computing net present value requires use of a discount rate equal to some minimum desired rate of return. This could be a business's weighted average cost of capital (WACC) (debt and equity) as computed the business's finance department. If capital costs the business 10%, the business is not likely to invest that capital for an 8% return.

The discount rate (say, 10%) determines the discount factor for each year that is applied to that year's cash flow to convert it to today's dollars. The discount factor for year n can be computed as: discount factor =1/(1+i)n, where i is the target rate of return. So at a discount rate of 10% in Year 1, discount factor =1/(1.1), or 0.909. The actual net present value benefit is calculated by “discounting” the actual return-on-investment benefit by this factor. Thus, an actual return-on-investment of $1,000,000, for example, one year into the future is $1,000,000×0.909, or $909,000.

Yet another benefit that may be calculated is an actual internal rate of return benefit. An internal rate of return is generally defined as the discount rate at which an investment's net present value is equal to zero. Generally, most businesses have a certain rate of return that it expects its investments to yield. This rate is above the opportunity cost of capital. If the internal rate of return of an investment is above the business's expected rate of return, the investment is generally considered attractive.

An actual internal rate of return is calculated by using the actual return-on-investment benefit and the actual net present value benefit, determining an interest rate that forces the actual net present value to be equal to zero.

Finally, another benefit that may be calculated is an actual payback period. This is generally defined as a time period required for the sum of benefits received from an investment to equal the value of the initial investment. A payback period is also commonly known as a breakeven period. To calculate an actual payback period, the actual cost of the improvement is compared to the cumulative actual cost benefit of the improvement from a time at which the business improvement was implemented. The cumulative actual cost benefit is determined using actual performance information.

Referring back to FIG. 3, storage device 304 may comprise one or more volatile and/or non-volatile memories, such as a read-only memory (ROM), random-access memory (RAM), electrically erasable programmable read-only memory (EEPROM), a hard drive, a floppy disk drive and floppy disk, or a flash memory. Storage device 304 may be used to store actual performance information relating to the operation vehicle 100 and/or to a vehicle operator/occupant. For example, such information may comprise a vehicle identification number, such as license plate number, VIN number, etc., a vehicle location, vehicle operational parameters such as speed, RPM, fuel information, odometer readings, oil pressure, load status, the time that an operator/occupant spends in various duty states (i.e., loading, unloading, resting, etc), miles driven between stops, and times associated with this information (i.e., the date and time of each stop, a date and time associated with each position of vehicle 100, etc). Other information stored within storage device 304 may include executable computer instructions for processor 302 to communicate with vehicle 100 and one or more central stations 102.

In alternative embodiments, actual performance information is not only stored and retrieved in storage device 304, but may also be stored and retrieved from one or more logistics systems. In another embodiment, all actual performance information is retrieved from these logistics systems. For example, actual performance information may include payroll information obtained from a payroll or timekeeping system. Actual information relating to fuel purchases, fuel efficiencies, or fuel taxes may be obtained from a fuel tax system. Information relating to maintenance of vehicles may be obtained from a maintenance database. Information relating to routes of travel, number of stops per time period, miles traveled, speeds, etc. may be obtained from a dispatch system or communication system. These logistics systems, and others, may additionally comprise the source of estimated information for use in benefit measurements. For example, a rate of pay for one or more vehicle operators might be stored in a payroll system. This rate of pay could be used in a benefit calculation as the basis for an actual rate of pay as well as an “estimated” rate of pay.

Storage device 304 additionally may store a program of machine-readable instructions executable by a digital processing apparatus, such as processor 302, to perform a method for measuring a benefit of a business improvement. The program may be written in any suitable programming language, such as Microsoft Excel Visual Basic, for example. The program typically will utilize a Graphical User Interface, or GUI, to allow a user enter information and modify various constraints used to calculate a benefit of a business improvement.

The program will typically allow a user to calculate actual cost savings for various predefined “segments” to better understand how each segment contributes to the overall cost savings, and thus a benefit, when utilizing an improvement. In an example where a wireless communication system was purchased to track and record vehicle and driver characteristics, a fleet manager may want to know how much cost savings was achieved for various segments of a driver's daily activity. For instance, the fleet manager may want to measure an overall cost savings of using such a communication system and, in addition, determine a cost savings associated with only pre-trip activity. In this case, the program will use actual information from storage device 304 that pertains to pre-trip activity, such as the time spent filling out paperwork, the time to perform a vehicle inspection, etc. The program generally can provide a cost savings pertaining only to the particular segment or segments of interest. Other predefined segments may include an in-route segment (cost savings pertaining to information obtained during a “driving” portion of a delivery), an administrative segment (cost savings pertaining to the processing of “paperwork”, such as the recordation of information at a vehicle and/or processing information at a host location), a fuel-tax segment (cost savings pertaining to the preparation of fuel tax reporting), a fuel economy segment (cost savings pertaining to tracking fuel economy), a route efficiency segment (cost savings of routing vehicles more efficiently), a backhaul efficiency segment (cost savings of directing empty trucks more efficiently to pickup points), a driver contact segment (cost savings pertaining to more efficient communications between drivers and fleet dispatch), a customer service segment (cost savings pertaining to the efficiency of customer service agents using the wireless communication system), and/or an additional revenue stop segment (revenue gains realized). Of course, other segments could be also be used either in addition, or alternatively to, the ones mentioned herein.

The program will typically also allow a user to calculate a benefit over various time periods. For example, a fleet operator may want to know what his cost savings or profitability was over the past day, past quarter, past year, year-to-date, etc. are using the wireless communication system. In this case, actual information from vehicles during the specified time period is used to calculate the actual cost savings, profit, or other benefit.

User interface 306 allows a user at central station 102 (or wherever apparatus 300 is located) to enter instructions into processor 302, typically comprising a keyboard or keypad and a visual display device. Of course, user interface 306 could alternatively comprise other types of interfaces, such as a microphone for entering audible commands, a pointing device such as a mouse, light pen, trackball, and/or a speaker for generating audible information to a vehicle operator. Other types of well-known devices could be used, either alternatively or in combination, with the devices just mentioned. In addition, user interface 306 typically comprises a display device, such as a computer terminal, for allowing the user to view results of a benefit analysis.

User interface 306 allows a user to request a benefit measurement based on actual performance information stored in storage device 304. As part of this inquiry, the user may need to enter estimated performance information relating to various aspects of his or her business. In another embodiment, this estimated performance information is pre-stored in storage device 304 for use by processor 302.

The estimated performance information may comprise “hard” information, (i.e., information that is known absolutely, such as each vehicle operator rate of pay, a rate of overtime pay, a number of vehicles owned by the user's employer or a number of vehicles to be used to determine the benefit, a cost of benefits paid to various personnel, a time period to retrieve actual performance information), educational guesses for various portions of information (i.e., estimated information for costs associated with various tasks performed by vehicle operators/occupants, and/or estimated times for completing such tasks, average miles per gallon per vehicle, or the average number of stops in a day per vehicle), and/or previously-measured results (i.e., actual miles per gallon derived from manual calculations, on-board trip recorders, or other methods). All or a portion of this information may be entered by the user at the time that the request to determine the benefit is entered, or it may have been previously entered and stored in storage device 304 (or some other storage device).

In addition to “hard” information, “soft” information may be used to calculate a return-on-investment. This information could be classified as actual information or estimated information for purposes of calculating a return-on-investment. For example, a value could be assigned to a present level of customer satisfaction., The value could be measured in a number of ways, for example, determining the number of calls made to a customer service department. Or the value could be arbitrarily assigned by using customer satisfaction surveys.

External interface 308 allows processor 302 to communicate with one or more remotely located entities, such as central station 102, dispatch center 106, and/or third party center 108, depending on the location of apparatus 300. External interface 308 comprises one or more devices for allowing various forms of two-way communications to occur between the various entities. Examples of external interface 308 comprise a telephonic interface, an optical interface, a data interface (for example, interfacing with a T1 line, T3 line, or the like), an internet interconnection device such as a router, a wireless transceiver, or a combination of these devices, as well as others. External interface 308 allows actual performance information to be received by apparatus 300 via remote location 102. In an embodiment where actual information from vehicle 100 is received directly by apparatus 300, rather than being routed through central station 102, interface 308 may not be necessary to receive actual performance information.

In one embodiment, apparatus 300 comprises a transceiver 310, which allows information to be received from vehicles (either directly or indirectly) and/or allows information to be transmitted to a remote location. Transceiver 310 comprises circuitry to modulate information from processor 302 and convert the modulated information into high frequency signals suitable for wireless transmission. Similarly, transceiver 310 also comprises circuitry to convert received high frequency communication signals into signals suitable for demodulation and subsequent processing by processor 302. Transceiver 310 may be used to receive actual performance information if, for instance, apparatus 300 was located at a dispatch center whereby wireless communications to MCT 200 are accomplished directly through a wireless communication network without the need for using remote location 102.

FIG. 4 is a flow diagram illustrating a method for determining a benefit of a business improvement. The method may be embodied as a set of machine-readable instructions executable by a digital processing apparatus and stored in storage device 304.

In step 400, actual performance information is received by apparatus 300 through transceiver 310 or external interface 308, as the case may be, and stored in storage device 304, as shown in step 402. For example, the actual performance information might be transmitted by one or more MCT's 200 using a wireless communication system.

In step 404, a user of apparatus 300 initiates a measurement of a business improvement by entering a request using user interface 306. The user may additionally enter estimated performance and/or other measured information for use in determining the benefit, as described elsewhere herein.

In step 406, processor 302 retrieves actual performance information from storage device 304 and/or other logistics systems. In step 408, processor 302 then calculate a benefit based on the actual performance data and the estimated performance information provided by the user and/or previously stored information. For example, a fleet operator may choose to purchase a wireless communication system so that vehicle performance can be measured, messages can be sent between a dispatch office and the vehicles, and vehicles may be located efficiently. The fleet operator may want to know the benefit of implementing the improvement (the wireless communication system) as measured by calculating an actual return-on-investment. The fleet owner estimates that each driver in his fleet spends 8.5 hours working per day and is being paid $30 per hour plus $45 per hour for overtime (any time greater than 8 hours per day). After purchasing the wireless communication system, drivers are only working 8 hours per day because of efficiencies gained using the wireless communication system (this information is actual information stored in memory 304). The cost savings per day is equal to $22.50 (half an hour of overtime pay eliminated) per driver. If there are 100 drivers in the fleet operator's employ, the cost savings per day would be equal to $2,250. An actual return-on-investment, for instance, could then be calculated by multiplying the cost savings in salary per day by an amount of expected life of the wireless communication system (in days), then subtracting the cost of the wireless communication system. Such cost may include initial costs, such as the cost of purchasing the equipment, as well as ongoing costs, such as monthly messaging costs. The benefit per predefined “segment” could also be calculated by using actual vs. estimated information pertaining to the chosen segment or segments under consideration.

The benefit may then provided to the user via user interface 306, provided to another entity, such as another user located either locally or remotely to apparatus 300, or stored locally or remotely in a second storage device, and/or in storage device 304.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

We claim:

1. A method for measuring a benefit of a business improvement, comprising operations of:
receiving actual performance information;
storing the actual performance information in a storage device;
retrieving the actual performance information; and
calculating the benefit of implementing the business improvement by comparing the actual performance information to estimated performance information.

2. The method of claim 1 wherein the operation of calculating the benefit of implementing the business improvement comprises calculating an actual return-on-investment of the business improvement.

3. The method of claim 1 wherein the operation of calculating the benefit of implementing the business improvement comprises calculating an actual total cost of ownership.

4. The method of claim 1 wherein the operation of calculating the benefit of implementing the business improvement comprises calculating an actual net present value.

5. The method of claim 1 wherein the operation of calculating the benefit of implementing the business improvement comprises calculating an actual internal rate of return.

6. The method of claim 1 wherein the operation of calculating the benefit of implementing the business improvement comprises calculating an actual payback period.

7. The method of claim 1 wherein the operation of calculating the benefit of implementing the business improvement comprises calculating an actual cost savings.

8. The method of claim 1 wherein the operation of calculating the benefit of implementing the business improvement comprises calculating an actual revenue increase.

9. The method of claim 1 wherein the actual performance information comprises a time associated with a predefined event.

10. The method of claim 2 wherein calculating the actual return-on-investment comprises operations of:
determining a first profitability figure over a selected time period using the actual performance information;
determining a second profitability figure over a length of time equal to the selected time period using the estimated performance information;
determining a profitability difference between the first profitability figure and the second profitability figure; and
subtracting a cost of the improvement from the profitability difference.

11. The method of claim 1 further comprises an operation of entering the estimated information via a Graphical User Interface.

12. The method of claim 1 wherein the estimated information is retrieved from one or more logistic information systems.

13. An apparatus measuring a benefit of a business improvement, comprising:
an interface for receiving actual performance information;
a storage device for storing the actual performance information and for storing estimated performance information;
a processor for retrieving the actual performance information and the estimated performance information and for calculating the benefit using at least the actual performance information and the estimated performance information.

14. The apparatus of claim 13, wherein the benefit comprises an actual return-on-investment of the improvement.

15. The apparatus of claim 13 wherein the actual performance information comprises a time associated with a predefined event.

16. The apparatus of claim 13, wherein the benefit comprises an actual total cost of ownership of the improvement.

17. The apparatus of claim 13, wherein the benefit comprises an actual net present value of the improvement.

18. The apparatus of claim 13, wherein the benefit comprises an actual internal rate of return of the improvement.

19. The apparatus of claim 13, wherein the benefit comprises an actual payback period of the improvement.

20. The apparatus of claim 14 wherein calculating the actual return-on-investment comprises:
determining first profitability figure over a selected time period using the actual performance information;
determining a second profitability figure over a length of time equal to the selected time period using the estimated performance information;
determining a profitability difference between the first profitability figure and the second profitability figure; and
subtracting a cost of the improvement from the profitability difference.

21. The apparatus of claim 14 wherein calculating the actual return-on-investment comprises:
determining a performance difference between actual performance information taken over a predetermined time period and estimated performance information estimated over a length of time equal to the predetermined time period;
calculating a profitability difference over the selected time period using the performance difference; and
subtracting a cost of the improvement from the profitability difference.

22. A signal-bearing medium tangibly embodying a program of machine-readable instructions executable by a digital processing apparatus to perform a method for measuring a benefit of a business improvement, said method comprising operations of:
receiving actual performance information;
storing the actual performance information in a storage device;
retrieving the actual performance information; and
calculating the benefit using at least the actual performance information and estimated performance information.

23. The signal-bearing medium of claim 22 wherein the actual performance information comprises a time associated with a predefined event.

24. The signal-bearing medium of claim 22 wherein the operation of calculating the benefit comprises the operation of calculating an actual return-on-investment.

25. The signal-bearing medium of claim 22 wherein the operation of calculating the benefit comprises the operation of calculating an actual total cost of ownership.

26. The signal-bearing medium of claim 22 wherein the operation of calculating the benefit comprises the operation of calculating an actual net present value.

27. The signal-bearing medium of claim 22 wherein the operation of calculating the benefit comprises the operation of calculating an actual internal rate of return.

28. The signal-bearing medium of claim 22 wherein the operation of calculating the benefit comprises the operation of calculating an actual payback period.

29. The signal-bearing medium of claim 24 wherein calculating the actual return-on-investment comprises operations of:
determining a first profitability figure over a selected time period using the actual performance information;
determining a second profitability figure over a length of time equal to the selected time period using the estimated performance information;
determining a profitability difference between the first profitability figure and the second profitability figure; and
subtracting a cost of the improvement from the profitability difference.

30. The signal-bearing medium of claim 24 wherein calculating the actual return-on-investment comprises operations of:
determining a performance difference between actual performance information taken over a predetermined time period and estimated performance information estimated over a length of time equal to the predetermined time period;
calculating a profitability difference over the selected time period using the performance difference; and
subtracting a cost of the improvement from the profitability difference.

31. A method for measuring a benefit of a business improvement, comprising operations of:
storing a first set of actual performance information prior to implementation of the business improvement;
storing a second set of actual performance information after implementation of the business improvement;
retrieving the first set and the second set of actual performance information; and
calculating the benefit of implementing the business improvement by comparing the first set and the second set of actual performance information.

32. The method of claim 31, wherein the benefit is selected from the group consisting of an actual return-on-investment, an actual total cost of ownership, an actual net present value, an actual internal rate of return, and an actual payback period.
